(19) United States
(12) Patent Application Publication
(10) Pub. No.: US 2024/0430958 A1
(43) Pub. Date: Dec. 26, 2024

(54) MULTI-LINK OPERATION ADAPTATION

(71) Applicant: MAXLINEAR, INC., Carlsbad, CA (US)

(72) Inventors: Marcos Martínez Vázquez, Barcelona (ES); Sigurd Schelstraete, Menlo Park, CA (US); Iñaki Val Beitia, Vitoria (ES)

(73) Assignee: MAXLINEAR, INC., Carlsbad, CA (US)

(21) Appl. No.: 18/752,682

(22) Filed: Jun. 24, 2024

Related U.S. Application Data
(60) Provisional application No. 63/509,747, filed on Jun. 22, 2023.

(51) Int. Cl. H04W 76/10; H04W 84/12; H04W 88/10

(52) U.S. Cl. CPC H04W 76/10; H04W 84/12; H04W 88/10

(57) ABSTRACT

A wireless access point includes a first sublayer and a second sublayer. The first sublayer may be operable to perform first operations in accordance with a first standard. The first standard may be associated with the wireless access point. The second sublayer may be communicatively coupled to the first sublayer and may include a protocol stack and an adaptive layer. The protocol stack may be operable to perform second operations in accordance with a second standard and may be operable to interface with a transmission medium to facilitate data transmissions between the wireless access point and a device. The adaptive layer may facilitate communications between the protocol stack and the first sublayer.

### CROSS REFERENCE TO RELATED APPLICATIONS

This U.S. Patent Application claims priority to U.S. Provisional Patent Application No. 63/509,747, titled “MULTI-LINK OPERATION ADAPTATION,” and filed on Jun. 22, 2023, the disclosure of which is hereby incorporated by reference in its entirety.

### TECHNICAL FIELD

This disclosure relates to wireless communication, and more specifically, to extending multi-link operations in a wireless network by adaptation.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi. Some 802.11 standards implement multi-link operations through multi-link devices. The multi-link operations include simultaneously using one or more channels in the wireless medium to communicate with a connected device (e.g., in accordance with the 802.11 standard).

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a wireless access point may include a first sublayer and a second sublayer. The first sublayer may be operable to perform first operations in accordance with a first standard. The first standard may be associated with the wireless access point. The second sublayer may be communicatively coupled to the first sublayer and may include a protocol stack and an adaptive layer. The protocol stack may be operable to perform second operations in accordance with a second standard. The protocol stack may interface with a transmission medium to facilitate data transmissions between the wireless access point and a device. The adaptive layer may facilitate communications between the protocol stack and the first sublayer.

In another embodiment, a method may include obtaining a first data frame from a first sublayer in a wireless access point. The first frame may correspond to a first standard associated with the first sublayer and the wireless access point. The method may also include adapting the first data frame from the first standard to a second standard to obtain an adapted frame. The adapted frame may correspond to a second standard. The method may further include transmitting the adapted frame to a protocol stack in the wireless access point. The second standard may be associated with the protocol stack.

In another embodiment, a system may include a first sublayer, a second sublayer, and a third sublayer. The first sublayer may be operable to perform first operations in accordance with a first standard. The first standard may be associated with a wireless access point. The second sublayer may be communicatively coupled to the first sublayer and may include a protocol stack and an adaptive layer. The protocol stack operable to perform second operations in accordance with a second standard including interfacing with a transmission medium to facilitate data transmissions between the wireless access point and a device. The third sublayer may be communicatively coupled to the first sublayer. The third sublayer may be operable to perform third operations in accordance with the first standard. The third sublayer may be operable to interface with a second transmission medium to facilitate data transmissions between the wireless access point and a second device.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example wireless access point including an adaptation to multi-link operations;

FIG. 2 illustrates a block diagram of an example wireless access point including an adaptation to multi-link operations;

FIG. 3 illustrates a flowchart of an example method of adaptation to multi-link operations in a multi-link device; and

FIG. 4 illustrates an example computing device.

### DETAILED DESCRIPTION

Institute of Electrical and Electronics Engineers (IEEE) 802.11be introduces multi-link operations that allows a wireless access point to operate over three separate channels, including 2.4 GHz, 5 GHz, and/or 6 GHz. To accommodate such operations, the medium access control (MAC) layer in the wireless access point may be separated into an upper MAC and at least one lower MAC, where there may be a lower MAC for each channel. For example, communications using the 2.4 GHz may be associated with a first lower MAC, communications using the 5 GHz channel may be associated with a second lower MAC, and so forth. The upper MAC may be common to each of the lower MACs and may be configured to distribute frames to each of the lower MACs. In such an arrangement, the wireless access point may be limited in adding additional channels as the existing three channels become congested.

Aspects of the present disclosure address these and other limitations by including an adaptive layer to the wireless access point, where the adaptive layer may be operable to adapt a frame from the upper MAC (e.g., an 802.11 frame) to a frame associated with a non-IEEE 802.11 standard, such as (ITU-T) G.hn, Multimedia over Coax Alliance (MoCA), fiber optics, passive optical network (PON), Ethernet, Bluetooth, LiFi, and/or other standards. As such, the number of channels that may be utilized by the wireless access point may be extended beyond the three typically associated with 802.11 communications, and may include other non-IEEE 802.11 standards, which may at least improve throughput, latency, and/or bandwidth in the wireless access point.

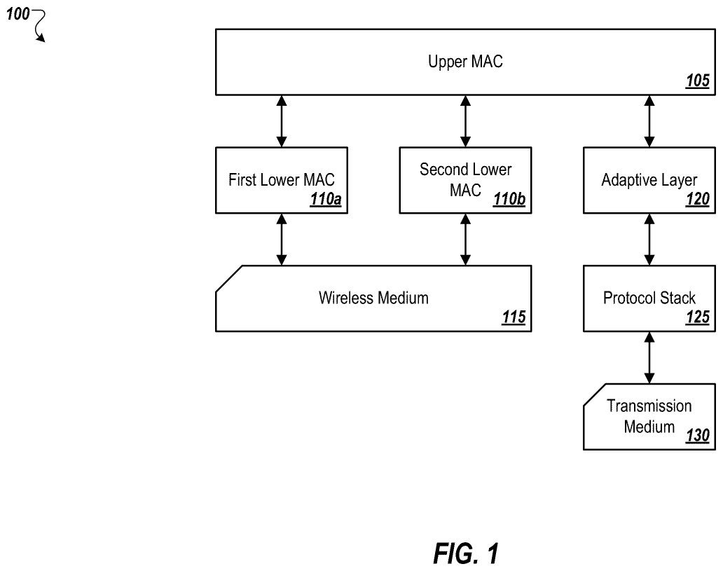

FIG. 1 illustrates a block diagram of an example wireless access point 100 including an adaptation to multi-link operations, in accordance with at least one embodiment of the present disclosure. The wireless access point 100 may include an upper medium access control (MAC) 105, a first lower MAC 110a, a second lower MAC 110b, collectively referred to as lower MACs 110, an adaptive layer 120, and a protocol stack 125.

In some instances, the wireless access point 100 may be a multi-link device that may be operable to support multi-link operations with one or more connected devices communicatively coupled with the wireless access point 100, such as via a wireless medium 115. By implementing multi-link operations, the wireless access point 100 may be operable to use one or more channels in the wireless medium 115 to transmit data to and/or receive data from the connected devices. For example, in instances in which the wireless access point 100 is operable to wirelessly communicate with a particular device using a 2.4 GHz channel and a 5 GHz channel, the wireless access point 100 may transmit data to the particular device by transmitting a first portion of the data via the 2.4 GHz channel and a second portion of the data via the 5 GHz channel. The wireless access point 100 may be operable to utilize one or more of the available channels to communicate with the connected devices, which may improve throughput and/or reduce latency in transmissions between the wireless access point 100 and the connected devices.

In some instances, the wireless access point 100 may be operable to perform operations using a first standard. For example, the wireless access point 100 may perform operations using the IEEE 802.11 standard (hereinafter 802.11) and/or amendments to the 802.11 standard, such as IEEE 802.11be. The wireless access point 100 may be operable to communicate with one or more connected devices via at least the wireless medium 115 and using one or more channels.

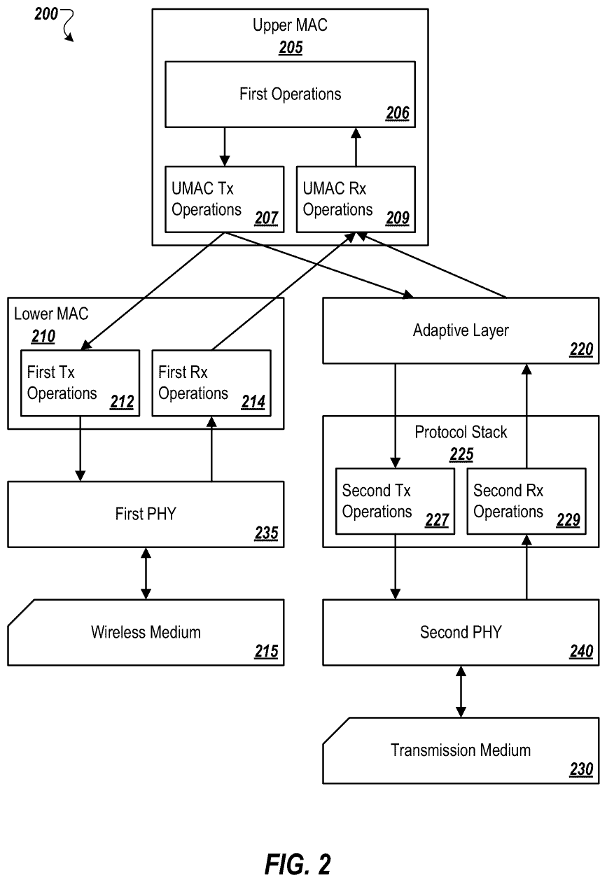

The wireless access point 100 may utilize the upper MAC 105 to facilitate communications (e.g., data transfer) with devices connected to the wireless access point 100 via a lower MAC (e.g., the first lower MAC 110a and/or the second lower MAC 110b) and/or the adaptive layer 120, as described herein. The upper MAC 105 may be a first sublayer in the wireless access point 100 and may be operable to perform first operations in accordance with the first standard employed by the wireless access point 100. For example, in instances in which the wireless access point 100 is configured as an 802.11 device, the first operations performed by the upper MAC 105 may be in accordance with 802.11. The first operations may be further described relative to the wireless access point 200 of FIG. 2.

The upper MAC 105 may be communicatively coupled with the lower MACs 110 and/or the adaptive layer 120. Alternatively, or additionally, the upper MAC 105 may be common relative to at least the lower MACs 110 and the adaptive layer 120. As such, the upper MAC 105 may facilitate data transfer using one or more channels and/or standards via the first lower MAC 110a, the second lower MAC 110b, and/or the adaptive layer 120.

The wireless access point 100 may utilize the lower MACs 110 and/or the adaptive layer 120 to facilitate communications with devices connected to the wireless access point 100 via the wireless medium 115 and/or a transmission medium 130. Alternatively, or additionally, the lower MACs 110 and/or the adaptive layer 120 may be operable to individually communicate with an associated physical layer (e.g., as illustrated and described relative to the wireless access point 200 of FIG. 2) which may, in turn, interface with the wireless medium 115 and/or the transmission medium 130.

The lower MACs 110 may be a second sublayer in the wireless access point 100 and may be operable to perform second operations in accordance the first standard employed by the wireless access point 100. For example, in instances in which the wireless access point 100 is configured as an 802.11 device, the second operations performed by the lower MACs 110 may be in accordance with 802.11. The second operations may be further described relative to the wireless access point 200 of FIG. 2.

Alternatively, or additionally, the second sublayer may be a combination of the adaptive layer 120 and the protocol stack 125, where the combination of the adaptive layer 120 and the protocol stack 125 may be operable to perform the same or similar functions in the wireless access point 100 relative to the lower MACs 110. For example, the first lower MAC 110a may obtain a first data frame (or simply, frame) from the upper MAC 105 and may prepare the first frame for transmission via the wireless medium 115, and the adaptive layer 120 may obtain a second frame from the upper MAC 105 and may adapt the second frame for use by the protocol stack 125, after which, the protocol stack 125 may prepare the second frame for transmission via the transmission medium 130.

In some instances, the second sublayer (e.g., the first lower MAC 110a) may utilize the same standard as the standard utilized by the upper MAC 105. For example, in instances in which the upper MAC 105 is configured for operations in accordance with 802.11, the lower MACs 110 may be configured for operations in accordance with 802.11.

Alternatively, or additionally, the second sublayer (e.g., the adaptive layer 120 and the protocol stack 125) may perform operations in accordance with a second standard that may differ the standard utilized by the upper MAC 105. For example, in instances in which the upper MAC 105 is configured for operations in accordance with 802.11, the protocol stack 125 may be configured for operations in accordance with the International Telecommunication Union Telecommunication Standardization Sector (ITU-T) G.hn standard and/or another standard that may differ from 802.11. The second standard may include a wired and/or a wireless standard, such as G.hn, Multimedia over Coax Alliance (MoCA), fiber optics, passive optical network (PON), Ethernet, Bluetooth, LiFi, and/or other standards. In these and other embodiments, the wireless access point 100 may be operable to support communications via one or more standards, where the upper MAC 105 may perform first operations in accordance with a first standard (e.g., 802.11), the lower MACs 110 may perform second operations in accordance with the first standard, and the adaptive layer 120 and the protocol stack 125 may perform third operations in accordance with a second standard (e.g., G.hn, MoCA, etc.).

The protocol stack 125 may be associated with any standard for transmission (such as G.hn, Ethernet, MoCA, etc., as described herein), which may include a wired connection or a wireless connection as the transmission medium 130. In instances in which the protocol stack 125 is operable to perform operations in accordance with the same standard as the lower MACs 110 (e.g., both in accordance with 802.11), the transmission medium 130 may be the same as the wireless medium 115 and/or the adaptive layer 120 may be substantially inoperative, or in other words, the adaptive layer 120 may not be needed as an interface between the upper MAC 105 and the protocol stack 125 due to the same standard between utilized between them.

The protocol stack 125 may be operable to perform standard defined operations (e.g., which may differ from the operations performed by the lower MACs 110, as the standards may differ between the lower MACs 110 and the protocol stack 125) as part of data transfer via the transmission medium 130. For example, the upper MAC 105 may obtain data to be transferred and may generate one or more frames as part of the transmission. The protocol stack 125 may obtain the frame from the upper MAC 105 via the adaptive layer 120 and may perform operations to the frame for transmission via the transmission medium 130. In some instances, the protocol stack 125 may transmit the frame (e.g., subsequent to performing operations thereto) to a physical layer, such as illustrated and described relative to FIG. 2.

Alternatively, or additionally, the frames (and/or data) may travel through the wireless access point 100 in an opposite manner relative to direction described as the upper MAC 105 to the wireless medium 115 and/or the transmission medium 130. For example, a transmitted frame (including data) may be obtained from the transmission medium 130 by the protocol stack 125 (and/or by the physical layer described in FIG. 2). The protocol stack 125 may perform operations to the transmitted frame and the adaptive layer 120 may obtain the transmitted frame from the protocol stack 125 and perform an adaptation to the transmitted frame such that the transmitted frame may be in accordance with the standard associated with the upper MAC 105. Subsequent to the adaptation by the adaptive layer 120, the upper MAC 105 may obtain the transmitted frame, the transmitted frame having been converted to be in accordance with the standard associated with the upper MAC 105 and/or the wireless access point 100.

In some instances, the adaptive layer 120 may be operable to makes changes to a particular frame transmitted between the upper MAC 105 and the protocol stack 125, in either direction the particular frame may be traveling. For example, the upper MAC 105 may output frames that are in accordance with a first standard and the protocol stack 125 may process frames that are in accordance with a second standard, and the adaptive layer 120 may be operable to adapt a particular frame from the first standard to the second standard, as vice versa. The adaptive layer 120 may be operable to allow the upper MAC 105 and the protocol stack 125 to each perform operations in accordance with their respective standards, and the adaptive layer 120 may perform adjustments to frames between the upper MAC 105 and the protocol stack 125 to facilitate the operations in the standards native to the upper MAC 105 and the protocol stack 125.

In some instances, the adaptive layer 120 may be operable to support frame adaption between the upper MAC 105 and a particular standard associated with the protocol stack 125. For example, the upper MAC 105 may perform operations in accordance with 802.11 and the protocol stack 125 may perform operations in accordance with G.hn standard, and the adaptive layer 120 may adapt the 802.11 frames from the upper MAC 105 to be G.hn frames for use by the protocol stack 125.

In some instances, the adaptive layer 120 may be reconfigurable to support different standards associated with the protocol stack 125. For example, in a first instance, the adaptive layer 120 may be operable to support frame adaptation from 802.11 to G.hn for a first protocol stack 125, and in a second instance, the adaptive layer 120 may be operable to support frame adaptation from 802.11 to MoCA for a second protocol stack 125. The adaptive layer 120 may be dynamically reconfigured to adapt frames from the upper MAC 105 to any standard supported by the protocol stack 125.

In some instances, the adaptive layer 120 may be operable to preserve a priority (e.g., a quality of service designation) that may be associated with an obtained frame. For example, the adaptive layer 120 may obtain a frame from the upper MAC 105 that may include a priority, or a quality of service designation (e.g., video, voice, best effort, background), and may preserve the priority in the adapted frame generated by the adaptive layer 120 for use by the protocol stack 125. In instances in which the standard implemented by the protocol stack 125 does not use a priority, the adaptive layer 120 may drop the priority and/or not include the priority in the adapted frame. For example, in instances in which Ethernet is the standard implemented in the protocol stack 125, a frame from the upper MAC 105 that includes a priority may be dropped in the adapted frame from the adaptive layer 120 as Ethernet may not implement priority associated with frames therein.

The adaptive layer 120 may be operable to utilize a priority associated with a frame in instances in which the standard implemented by the protocol stack 125 is configured to utilize a priority. For example, in instances in which the standard associated with the protocol stack 125 is G.hn, MoCA, fiber optics, and/or any other standard that may implement a priority designation, a particular priority associated with a frame from the upper MAC 105 may be preserved by the adaptive layer 120 into the adapted frame, such that the particular priority may continue to be utilized after processing by the protocol stack 125. Described another way, the adaptive layer 120 may be operable to perform an encapsulation of a frame obtained from the upper MAC 105 (e.g., an encapsulation of a MAC service data unit (MSDU) from the upper MAC 105) for use by the protocol stack 125, and the encapsulated frame may include the priority when the protocol stack 125 is configured to utilize a priority and/or the encapsulated frame may not include the priority when the protocol stack 125 is not configured to utilize a priority.

Modifications, additions, or omissions may be made to the wireless access point 100 without departing from the scope of the present disclosure. For example, the designations of different elements in the manner described is meant to help explain concepts described herein and is not limiting. Further, the wireless access point 100 may include any number of other elements or may be implemented within other systems or contexts than those described. For example, any of the components of FIG. 1 may be divided into additional or combined into fewer components.

FIG. 2 illustrates a block diagram of an example wireless access point 200 including an adaptation to multi-link operations, in accordance with at least one embodiment of the present disclosure. The wireless access point 200 may include an upper medium access control (MAC) 205, a lower MAC 210, an adaptive layer 220, a protocol stack 225, a first physical layer (PHY) 235, and a second PHY 240. The upper MAC 205 may include first operations 206, upper MAC transmit operations 207, and upper MAC receive operations 209. The lower MAC 210 may include first transmit operations 212 and first receive operations 214. The protocol stack 225 may include second transmit operations 227 and second receive operations 229.

Some components of the wireless access point 200 may be the same or similar as similarly named and/or numbered components of the wireless access point 100 of FIG. 1. For example, the upper MAC 205, the lower MAC 210, the adaptive layer 220, and/or the protocol stack 225 of FIG. 2 may be the same or similar as the upper MAC 105, the first lower MAC 110a, the adaptive layer 120, and/or the protocol stack 125 of FIG. 1, respectively.

The upper MAC 205 may perform the first operations 206 with respect to data or frames to be transmitted and/or received. The first operations 206 may include, but not be limited to, IEEE 802 controlled and/or uncontrolled port filtering, MAC service data unit (MSDU) rate limiting, aggregated MSDU (A-MSDU) aggregation (for the upper MAC transmit operations 207), and/or A-MSDU de-aggregation (for the upper MAC receive operations 209). The first operations 206 may be performed with respect to frames transmitted and/or received by the upper MAC 205. For example, the first operations 206 may be performed on a first frame transmitted from the upper MAC 205 to the lower MAC 210 and the first operations 206 may be performed on a second frame obtained by the upper MAC 205 from the adaptive layer 220.

The upper MAC transmit operations 207 may include one or more operations performed by the upper MAC 205 on frames to be transmitted from the upper MAC 205, such as to the lower MAC 210 and/or the adaptive layer 220. The upper MAC transmit operations 207 may include, but not be limited to, power save (PS) defer queueing, sequence number assignment, packet number assignment, MAC protocol data unit (MPDU) encryption, and/or traffic identifier (TID) to link mapping. Alternatively, or additionally, the upper MAC receive operations 209 may include one or more operations performed by the upper MAC 205 on frames to be obtained by the upper MAC 205, such as from the lower MAC 210 and/or the adaptive layer 220. The upper MAC receive operations 209 may include, but not be limited to, link merging, block acknowledgement (ack) scoreboarding, duplicate detection per SN, MPDU decryption, block ack buffering and/or reordering per sequence number (SN), and/or replay detection per packet number (PN).

The first transmit operations 212 in the lower MAC 210 may include operations to a frame obtained from the upper MAC 205 in preparation for transmitting the frame to the first PHY 235. The first transmit operations 212 may include, but not be limited to, MPDU header creation, cyclic redundancy check (CRC) creation, and/or aggregated MPDU (A-MPDU) aggregation. Subsequent to the first transmit operations 212 being performed relative to a particular frame, the frame may be transmitted to the first PHY 235. The first PHY 235 may provide an interface between the wireless access point 200 and a wireless medium 215. For example, the first PHY 235 may perform any additional operations to a particular frame subsequent to transmission of the particular frame, and/or the first PHY 235 may obtain frames from the wireless medium 215 and perform initial processing to the obtained frames, prior to transmitting the obtained frames to the lower MAC 210 and/or the upper MAC 205.

Upon receiving an obtained frame from the first PHY 235, the lower MAC 210 may perform the first receive operations 214 to the obtained frame. The first receive operations 214 may include, but not be limited to, A-MPDU de-aggregation, MPDU header validation, CRC validation, address filtering, and/or block ack scoreboarding. The upper MAC 205 may be operable to obtain the frame from the lower MAC 210 (e.g., subsequent to the first receive operations 214) and perform the upper MAC receive operations 209 to the frame. The upper MAC receive operations 209 may include, but not be limited to, link merging, block ack scoreboarding, duplicate detection per SN, MPDU decryption, block ack buffering and/or reordering per SN, and/or replay detection per PN.

The upper MAC 205 may perform the same or similar operations with respect to the adaptive layer 220 and/or the protocol stack 225 as described relative to the lower MAC 210. In some instances, the upper MAC 205 may perform the first operations 206, the upper MAC transmit operations 207, and/or the upper MAC receive operations 209 without consideration to the connected component, whether the connected component be the lower MAC 210 or the adaptive layer 220. For example, the upper MAC 205 may consider the lower MAC 210 and/or the adaptive layer 220 as a black box and the upper MAC 205 may perform operations independent of what may be included in the black box.

In some instances, the second transmit operations 227 and/or the second receive operations 229 may be similar to the first transmit operations 212 and/or the first receive operations 214, respectively, in view of the standard supported by the protocol stack 225 and the lower MAC 210, respectively. For example, in the transmit direction, in instances in which the standard associated with the protocol stack 225 is the same as the standard for the lower MAC 210 (e.g., 802.11), the second transmit operations 227 and/or the second receive operations 229 may be the as the first transmit operations 212 and/or the first receive operations 214, respectively. In another example, in instances in which the lower MAC 210 implements a first standard and the protocol stack 225 implements a second standard, the first transmit operations 212 may be similar to the second transmit operations 227 in that both may be operable to obtain a frame from the upper MAC 205 and perform operations to the frame in preparation for transmission to the first PHY 235 and the second PHY 240, respectively, and subsequent transmission via the wireless medium 215 and the transmission medium 230, respectively.

Similarly, in the receive direction, in instances in which the lower MAC 210 implements a first standard and the protocol stack 225 implements a second standard, the first receive operations 214 may be similar to the second receive operations 229 in that both may be operable to obtain a frame from the first PHY 235 and the second PHY 240, respectively, and perform operations to the frame in preparation for transmission to the upper MAC 205.

In these and other embodiments, both the lower MAC 210 (and the operations performed therein) and the protocol stack 225 (and the operations performed therein) may be dependent on the standard implemented. For example, the first transmit operations 212 and the first receive operations 214 may depend on the 802.11 standard implemented by the lower MAC 210 (and/or the upper MAC 205). In another example, the second transmit operations 227 and the second receive operations 229 may depend on a different standard implemented by the protocol stack 225. The different standard may include G.hn, MoCA, optical fiber, Ethernet, PON, and/or other transmission standards. In some instances, the standard associated with the lower MAC 210 and the protocol stack 225 may be the same. The first PHY 235 and the wireless medium 215 may be based on the standard implemented by the lower MAC 210 (e.g., 802.11) and the second PHY 240 and the transmission medium 230 may be based on the standard implemented by the protocol stack 225 (e.g., one of the different standards described herein).

In these and other embodiments, the adaptive layer 220 may be operable to convert frames from the upper MAC 205, having a first standard, to an adapted frame to be used by the protocol stack 225, having a second standard. As such, the upper MAC 205 may be operable to perform operations (e.g., at least the first operations 206, the upper MAC transmit operations 207, and/or the upper MAC receive operations 209) and the protocol stack 225 may be operable to perform operations (e.g., at least the second transmit operations 227 and/or the second receive operations 229) with respect to the individual standard that may be implemented therein (and which may differ between the upper MAC 205 and the protocol stack 225).

Modifications, additions, or omissions may be made to the wireless access point 200 without departing from the scope of the present disclosure. For example, the designations of different elements in the manner described is meant to help explain concepts described herein and is not limiting. Further, the wireless access point 200 may include any number of other elements or may be implemented within other systems or contexts than those described. For example, any of the components of FIG. 2 may be divided into additional or combined into fewer components.

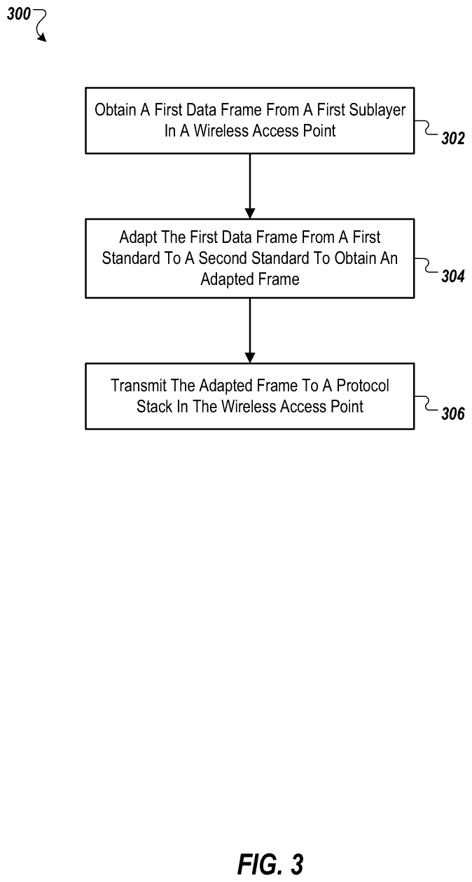

FIG. 3 illustrates a flowchart of an example method 300 of adaptation to multi-link operations in a multi-link device, in accordance with at least one embodiment of the present disclosure. The method 300 may be performed by processing logic that may include hardware (circuitry, dedicated logic, etc.), software (such as is run on a general purpose computer system or a dedicated machine), or a combination of both, which processing logic may be included in any computer system or device such as wireless access point 100 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 302, a first data frame may be obtained from a first sublayer in a wireless access point. The first data frame may correspond to a first standard that may be associated with the first sublayer and/or the wireless access point. The first sublayer may be an upper medium access control layer that may be configured to perform multi-link operations in the wireless access point. The first standard may be Institute of Electrical and Electronics Engineers (IEEE) 802.11, and/or amendments to the 802.11 standard, such as 802.11be.

At block 304, the first data frame may be adapted from the first standard to a second standard to obtain an adapted frame. The adapted frame may correspond to a second standard. The second standard may be any non-IEEE 802.11 standard. For example, the second standard may be one of G.hn, Multimedia over Coax Alliance (MoCA), fiber optics, passive optical network (PON), and/or Ethernet.

At block 306, the adapted frame may be transmitted to a protocol stack in the wireless access point. The second standard may be associated with the protocol stack.

In some instances, the first sublayer may be common to the protocol stack and a second sublayer. Alternatively, or additionally, the first sublayer may be operable to perform operations relative to at least the protocol stack and the second sublayer. The second sublayer may perform operations to a second data frame in accordance with the first standard.

Modifications, additions, or omissions may be made to the method 300 without departing from the scope of the present disclosure. For example, the designations of different elements in the manner described is meant to help explain concepts described herein and is not limiting. Further, the method 300 may include any number of other elements or may be implemented within other systems or contexts than those described.

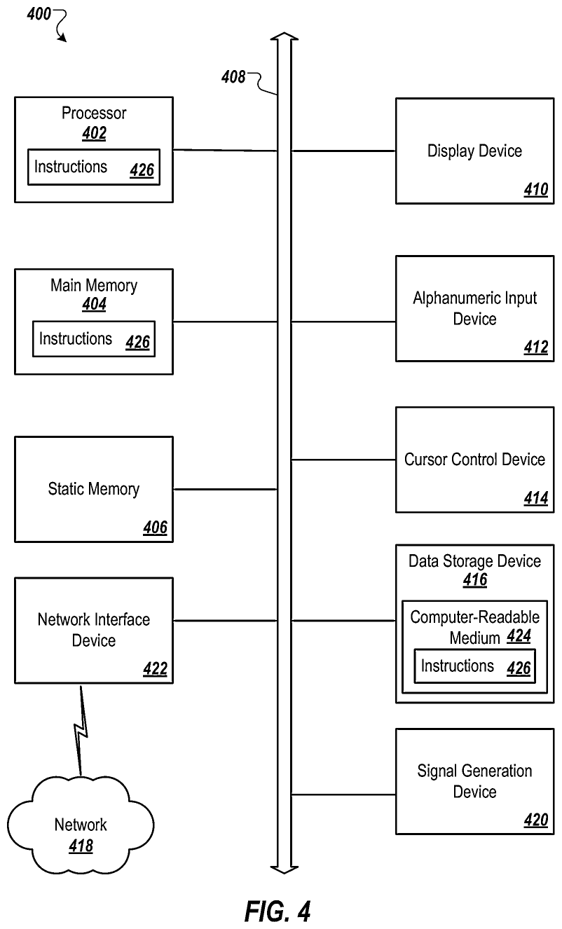

FIG. 4 illustrates an example computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 400 includes a processing device 402 (e.g., a processor), a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

The processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one implementation, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 424 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A wireless access point, comprising:
a first sublayer operable to perform first operations in accordance with a first standard, where the first standard is associated with the wireless access point; and
a second sublayer communicatively coupled to the first sublayer, comprising:
a protocol stack operable to perform second operations in accordance with a second standard and to interface with a transmission medium to facilitate data transmissions between the wireless access point and a device; and
an adaptive layer to facilitate communications between the protocol stack and the first sublayer.

2. The wireless access point of claim 1, further comprising a third sublayer communicatively coupled to the first sublayer, wherein:
the third sublayer is operable to perform third operations in accordance with the first standard; and
the third sublayer is operable to interface with a second transmission medium to facilitate data transmissions between the wireless access point and a second device.

3. The wireless access point of claim 2, wherein the first sublayer is common between the second sublayer and the third sublayer, and the first sublayer is operable to perform the first operations relative to at least the second sublayer and the third sublayer.

4. The wireless access point of claim 1, wherein the first sublayer is an upper medium access control layer configured to performed multi-link operations in the wireless access point.

5. The wireless access point of claim 1, wherein the first standard is Institute of Electrical and Electronics Engineers (IEEE) 802.11 and the 802.11be amendment.

6. The wireless access point of claim 1, wherein the second standard is a non-IEEE 802.11 standard.

7. The wireless access point of claim 6, wherein the second standard is one of G.hn, Multimedia over Coax Alliance, fiber optics, passive optical network, or Ethernet.

8. The wireless access point of claim 1, wherein the second operations correspond to the second standard and the transmission medium.

9. The wireless access point of claim 1, wherein the transmission medium is a wired connection.

10. A method, comprising:
obtaining a first data frame from a first sublayer in a wireless access point, the first data frame corresponding to a first standard associated with the first sublayer and the wireless access point;
adapting the first data frame from the first standard to a second standard to obtain an adapted frame, the adapted frame corresponding to a second standard; and
transmitting the adapted frame to a protocol stack in the wireless access point, wherein the second standard is associated with the protocol stack.

11. The method of claim 10, wherein the first sublayer is common to the protocol stack and a second sublayer, and the first sublayer is operable to perform first operations relative to at least the protocol stack and the second sublayer.

12. The method of claim 11, wherein the second sublayer performs second operations to a second data frame in accordance with the first standard.

13. The method of claim 10, wherein the first sublayer is an upper medium access control layer configured to perform multi-link operations in the wireless access point.

14. The method of claim 10, wherein the first standard is Institute of Electrical and Electronics Engineers (IEEE) 802.11 and the 802.11be amendment.

15. The method of claim 10, wherein the second standard is a non-IEEE 802.11 standard.

16. The method of claim 10, wherein the second standard is one of G.hn, Multimedia over Coax Alliance (MoCA), fiber optics, passive optical network (PON), or Ethernet.

17. A system, comprising:
a first sublayer operable to perform first operations in accordance with a first standard, where the first standard is associated with a wireless access point;
a second sublayer communicatively coupled to the first sublayer, comprising:
a protocol stack operable to perform second operations in accordance with a second standard comprising interfacing with a transmission medium to facilitate data transmissions between the wireless access point and a device; and
an adaptive layer to facilitate communications between the protocol stack and first sublayer; and
a third sublayer communicatively coupled to the first sublayer, wherein:
the third sublayer is operable to perform third operations in accordance with the first standard; and
the third sublayer is operable to interface with a second transmission medium to facilitate data transmissions between the wireless access point and a second device.

18. The system of claim 17, wherein the first sublayer is common between the second sublayer and the third sublayer, and the first sublayer is operable to perform the first operations relative to at least the second sublayer and the third sublayer.

19. The system of claim 17, wherein the first sublayer is an upper medium access control layer configured to performed multi-link operations in the wireless access point, and the third sublayer is a lower medium access control layer.

20. The system of claim 17, wherein the first standard is Institute of Electrical and Electronics Engineers 802.11be, and the second standard is one of G.hn, Multimedia over Coax Alliance, fiber optics, passive optical network, or Ethernet.
